(19) United States
(12) Patent Application Publication
(10) Pub. No.: US 2019/0337608 A1
(43) Pub. Date: Nov. 7, 2019

(54) COAXIALLY ALIGNED PROPELLERS OF AN AERIAL VEHICLE

(71) Applicant: Amazon Technologies, Inc., Seattle, WA (US)

(72) Inventors: Brian C. Beckman, Newcastle, WA (US); Noam Sorek, Zichron Yaccov (IL)

(21) Appl. No.: 16/508,020

(22) Filed: Jul. 10, 2019

Related U.S. Application Data
(63) Continuation of application No. 15/078,899, filed on Mar. 23, 2016.

(51) Int. Cl. B64C 11/50; B64C 39/02; B64C 11/48

(52) U.S. Cl. CPC B64C 11/50; B64C 39/024; B64C 2201/108; B64C 2201/027; B64C 11/48

(57) ABSTRACT

This disclosure describes aerial vehicles and systems for altering the noise generated by the rotation of a propeller during flight of the aerial vehicle. In some implementations, propellers of the aerial vehicle are paired in a coaxially aligned configuration in which the pair of propellers both rotate in the same direction, are rotationally phase aligned, and separated a defined distance so that the noise from high pressure pulse of the induced flow from the lower propeller is at least partially canceled out by the noise of the high pressure pulse of the induced flow from the upper propeller.

### CROSS REFERENCE TO RELATED APPLICATION

This application is a continuation of and claims priority to U.S. application Ser. No. 15/078,899, filed Mar. 23, 2016, which is incorporated herein by reference in its entirety.

### BACKGROUND

Sound is kinetic energy released by the vibration of molecules in a medium, such as air. In industrial applications, sound may be generated in any number of ways or in response to any number of events. For example, sound may be generated in response to vibrations resulting from impacts or frictional contact between two or more bodies. Sound may also be generated in response to vibrations resulting from the rotation of one or more bodies, such as propellers. Sound may be further generated in response to vibrations caused by fluid flow over one or more bodies. In essence, any movement of molecules, or contact between molecules, that causes a vibration may result in the emission of sound at a pressure level or intensity, and at one or more frequencies.

The use of unmanned aerial vehicles such as airplanes or helicopters having one or more propellers is increasingly common. Such vehicles may include fixed-wing aircraft, or rotary wing aircraft such as quad-copters (e.g., a helicopter having four rotatable propellers), octo-copters (e.g., a helicopter having eight rotatable propellers) or other vertical take-off and landing (or VTOL) aircraft having one or more propellers. Typically, each of the propellers is powered by one or more rotating motors or other prime movers.

With their ever-expanding prevalence and use in a growing number of applications, unmanned aerial vehicles frequently operate within a vicinity of humans or other animals. When an unmanned aerial vehicle is within a hearing distance, or earshot, of a human or other animal, noises generated by the unmanned aerial vehicle during operation may be detected by the human or the other animal. Such noises may include, but are not limited to, sounds generated by rotating propellers, operating motors or vibrating frames or structures of the unmanned aerial vehicle.

### BRIEF DESCRIPTION OF THE DRAWINGS

The detailed description is described with reference to the accompanying figures. In the figures, the left-most digit(s) of a reference number identifies the figure in which the reference number appears.

FIG. 1 depicts a top-down view of an aerial vehicle, according to an implementation.

FIG. 2 depicts a view of another aerial vehicle, according to an implementation.

FIG. 3 depicts an illustration of induced flows from coaxially aligned propellers, according to an implementation.

FIGS. 4A-4B depict a motor with a pair of coaxially aligned propellers, according to an implementation.

FIG. 5 is a flow diagram illustrating an example propeller adjustment process, according to an implementation.

FIG. 6 is a block diagram illustrating various components of an aerial vehicle control system, according to an implementation.

While implementations are described herein by way of example, those skilled in the art will recognize that the implementations are not limited to the examples or drawings described. It should be understood that the drawings and detailed description thereto are not intended to limit implementations to the particular form disclosed but, on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Additionally, as used herein, the term “coupled” may refer to two or more components connected together, whether that connection is permanent (e.g., welded) or temporary (e.g., bolted), direct or indirect (e.g., through an intermediary), mechanical, chemical, optical, or electrical. Furthermore, as used herein, “horizontal” flight refers to flight traveling in a direction substantially parallel to the ground (e.g., sea level), and that “vertical” flight refers to flight traveling substantially radially outward from the earth's center. It should be understood by those having ordinary skill that trajectories may include components of both “horizontal” and “vertical” flight vectors.

### DETAILED DESCRIPTION

This disclosure describes aerial vehicles, such as unmanned aerial vehicles, and systems for altering the noise generated by the rotation of a propeller during flight of the aerial vehicle. In some implementations, propellers of the aerial vehicle are paired in a coaxially aligned configuration in which the pair of propellers both rotate in the same direction (co-rotation), are in rotational phase alignment, and separated a defined distance so that the high pressure pulse of the induced flow from the lower propeller is canceled out by the high pressure pulse of the induced flow from the upper propeller.

In other implementations, the distance between the propellers, alignment of the propellers, and/or the pitch of the propeller blades may be altered to reduce the noise generated by the induced from the rotation of the propellers. For example, as the coaxially aligned propellers rotate, the noise generated by the high pressure pulse from the induced flows may be measured and one or more of the alignment of the propellers, the distance between the propellers, and/or the pitch of one or more of the propeller blades may be altered to decease the noise generated by the rotation of the propellers.

In some implementations, not all of the propulsion mechanisms may include paired coaxially aligned propellers. Likewise, in some implementations the distance between paired coaxially aligned propellers may be fixed, rather than adjustable. In such a configuration, the aerial vehicle may include one or more pairs of coaxially aligned propellers that will generate a force sufficient to lift the aerial vehicle and any engaged payload. In addition, the aerial vehicle may include one or more maneuverability propulsion mechanisms, such as propellers, that may be used to maneuver the aerial vehicle during flight. The lifting propulsion mechanism(s) and/or the maneuverability propulsion mechanism(s) may include paired coaxially aligned propellers, single propellers, or other forms of propulsion, as discussed below.

In some implementations, the paired coaxially aligned propellers may be adjustable. For example, it may be determined whether noise reduction is necessary. If noise reduction is not necessary, the position of the propellers may be adjusted so that they are approximately ninety degrees out of rotational phase alignment to one another. While such a position may result in more noise, the lift generated by the pair of propellers and/or the efficiency of the propulsion mechanism may be increased. However, if it is determined that noise reduction is desirable, the position of the propellers may be adjusted so that they are phase aligned and the high pressure forces at least partially cancel out thereby reducing the noise generated by the rotation of the propellers.

While the examples discussed herein primarily focus on UAVs in the form of an aerial vehicle utilizing multiple propellers to achieve flight (e.g., a quad-copter, octo-copter), it will be appreciated that the implementations discussed herein may be used with other forms and/or configurations of aerial vehicles.

As used herein, a “materials handling facility” may include, but is not limited to, warehouses, distribution centers, cross-docking facilities, order fulfillment facilities, packaging facilities, shipping facilities, rental facilities, libraries, retail stores, wholesale stores, museums, or other facilities or combinations of facilities for performing one or more functions of materials (inventory) handling. A “delivery location,” as used herein, refers to any location at which one or more inventory items (also referred to herein as a payload) may be delivered. For example, the delivery location may be a person's residence, a place of business, a location within a materials handling facility (e.g., packing station, inventory storage), or any location where a user or inventory is located, etc. Inventory or items may be any physical goods that can be transported using an aerial vehicle.

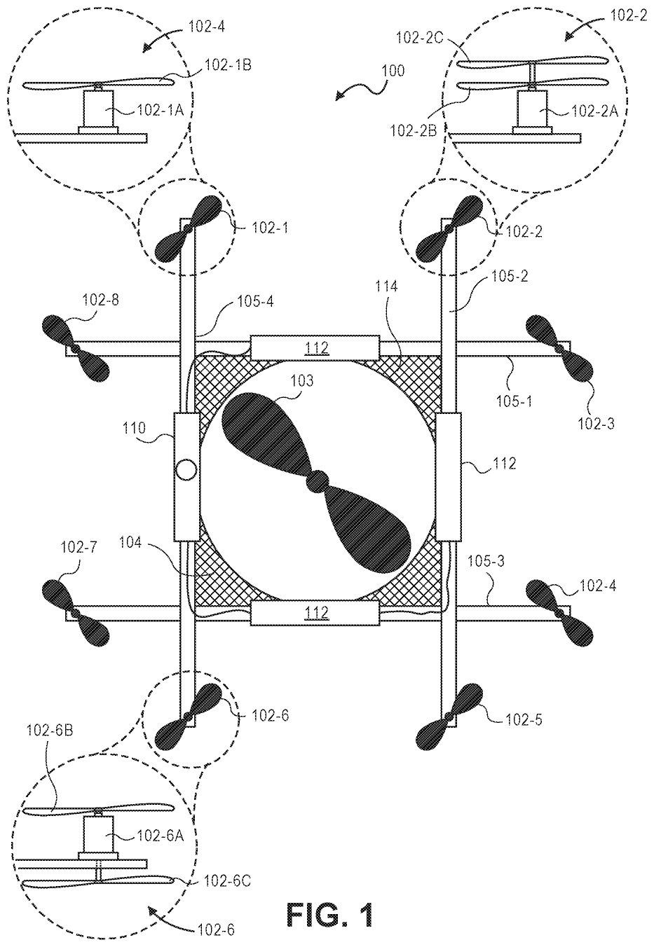

FIG. 1 illustrates a block diagram of a top-down view of a VTOL aerial vehicle 100, according to an implementation. The aerial vehicle 100 includes eight maneuverability propulsion mechanisms 102-1, 102-2, 102-3, 102-4, 102-5, 102-6, 102-7, 102-8 spaced about the body 104 of the aerial vehicle. In this example, the maneuverability propulsion mechanisms include a motor and one or more propellers. For example, as illustrated in the expanded view of maneuverability propulsion mechanism 102-1, one or more of the maneuverability propulsion mechanisms may include a motor 102-1A and a propeller 102-1B coupled to the shaft of the motor 102-1A. In another example, as illustrated by the expanded view of maneuverability propulsion mechanism 102-2, one or more of the maneuverability propulsion mechanisms 102-2 may include a motor 102-2A and a pair of coaxially aligned propellers 102-2B, 102-2C coupled to and rotated by the shaft of the motor 102-2A. In still another example, as illustrated by the expanded view of maneuverability propulsion mechanism 102-6, one or more of the maneuverability propulsion mechanisms may include a motor 102-6A, a first propeller 102-6B coupled to a first shaft that extends from one end of the motor 102-6A and a second propeller that is coaxially aligned with the first propeller but coupled to a second shaft that extends from a second side of the motor 102-6A.

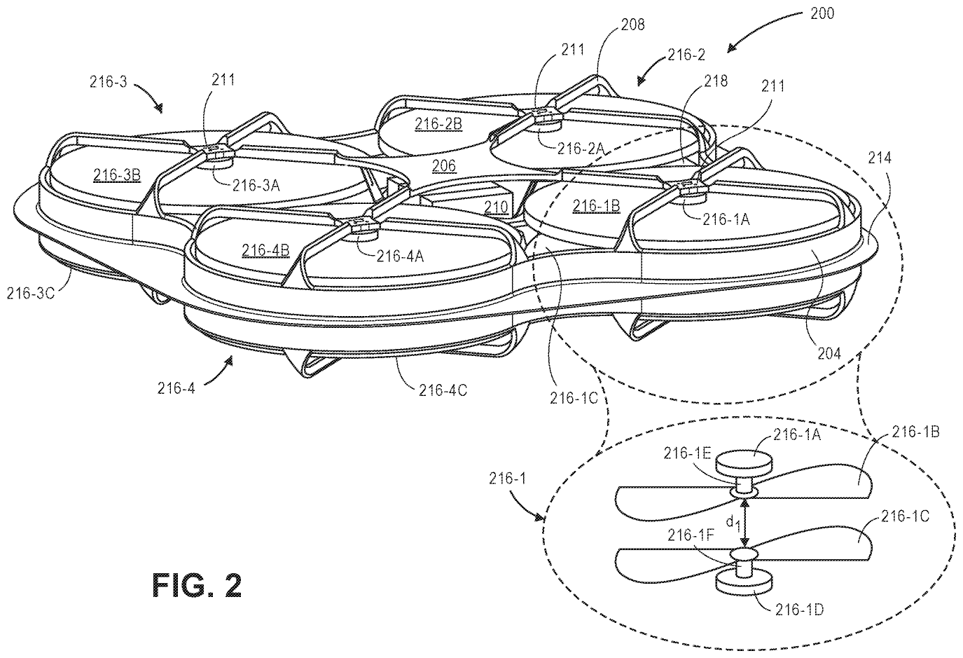

While the example maneuverability propulsion mechanisms illustrated in FIG. 1 only include one motor and one or more propellers, as discussed below with respect to FIG. 2, the maneuverability propulsion mechanisms may include more than one motor. Likewise, in some implementations, one or more of the maneuverability propulsion mechanisms may use other forms of propulsion to maneuver the aerial vehicle. For example, fans, jets, turbojets, turbo fans, jet engines, and the like may be used to maneuver the aerial vehicle.

The propellers may be any form of propeller (e.g., graphite, carbon fiber) and of a size sufficient to lift and/or guide the aerial vehicle 100 and any payload engaged by the aerial vehicle 100 so that the aerial vehicle 100 can navigate through the air, for example, to deliver a payload to a delivery location.

In addition to the maneuverability propulsion mechanisms 102, the aerial vehicle 100 may include one or more lifting propulsion mechanisms 103 that generate enough lift to at least counteract the force of gravity acting on the aerial vehicle. The lifting propulsion mechanism is of a size and configuration to generate a force that is approximately equal and opposite to the gravitational force applied to the aerial vehicle 100. For example, if the mass of the aerial vehicle, without a payload, is 20.00 kilograms (kg), the gravitational force acting on the aerial vehicle is 196.20 Newtons (N). If the aerial vehicle is designed to carry a payload having a mass between 0.00 kg and 8.00 kg, the lifting motor and lifting propulsion mechanism may be selected such that when generating a force between 196.00 N and 275.00 N, the lifting motor is operating in its most power efficient range.

As discussed in further detail below, the lifting propulsion mechanism may be configured in a manner similar to the maneuverability propulsion mechanisms. For example, the lifting propulsion mechanism 103 may include one or more motors and one or more propellers that are coaxially aligned and rotated by the motor. In other implementations, the lifting propulsion mechanism may use other forms of propulsion to lift the aerial vehicle. For example, fans, jets, turbojets, turbo fans, jet engines, and the like may be used to propel the aerial vehicle.

In implementations where the lifting propulsion mechanism includes one or more lifting propellers and one or more lifting motors, to counteract the angle of momentum of the lifting propulsion mechanism 103, one or more of the maneuverability propulsion mechanisms 102 may rotate in a direction opposite that of the lifting propulsion mechanism 103 to keep the aerial vehicle from rotating with the rotation of the lifting propulsion mechanism 103.

While this example includes eight maneuverability propulsion mechanisms and a lifting propulsion mechanism, in other implementations, more or fewer maneuverability propulsion mechanisms, and/or lifting propulsion mechanisms may be utilized. In some implementations, the aerial vehicle may only utilize maneuverability propulsion mechanisms that provide lift and maneuverability for the aerial vehicle. Likewise, in some implementations, the propulsion mechanisms may be positioned at different locations, angles and/or orientations on the aerial vehicle 100.

The body 104 or housing of the aerial vehicle 100 may likewise be of any suitable material, such as graphite, carbon fiber, and/or aluminum. In this example, the body 104 of the aerial vehicle 100 includes four rigid members 105-1, 105-2, 105-3, 105-4, or beams, also referred to herein as motor arms, arranged in a hash pattern with the rigid members intersecting and joined at approximately perpendicular angles. In this example, rigid members 105-1 and 105-3 are arranged parallel to one another and are approximately the same length. Rigid members 105-2 and 105-4 are arranged parallel to one another, yet perpendicular to rigid members 105-1 and 105-3. Rigid members 105-2 and 105-4 are approximately the same length. For example, each of the rigid members may be approximately 1.5 meters in length. In some implementations, all of the rigid members 105 may be of approximately the same length while, in other implementations, some or all of the rigid members may be of different lengths. Likewise, the spacing between the two sets of rigid members may be approximately the same or different.

While the implementation illustrated in FIG. 1 includes four rigid members 105 that are joined to form the body 104 and corresponding motor arms, in other implementations, there may be fewer or more components to the body 104. For example, rather than four rigid members, in other implementations, the body 104 of the aerial vehicle 100 may be configured to include six rigid members. In such an example, two of the rigid members 105-2, 105-4 may be positioned parallel to one another. Rigid members 105-1, 105-3 and two additional rigid members on either side of rigid members 105-1, 105-3 may all be positioned parallel to one another and perpendicular to rigid members 105-2, 105-4. With additional rigid members, additional cavities with rigid members on all four sides may be formed by the body 104. A cavity within the body 104 may be configured to include a payload engagement mechanism for the engagement, transport, and delivery of item(s) and/or containers that contain item(s) (generally referred to herein as a payload). In other implementations, such as the aerial vehicle discussed with respect to FIG. 2, the body may be formed of a mold that surrounds some or all of the propulsion mechanisms.

In some implementations, the aerial vehicle may be configured for aerodynamics. For example, an aerodynamic housing may be included on the aerial vehicle that encloses the aerial vehicle control system 110, one or more of the rigid members 105, the body 104, and/or other components of the aerial vehicle 100. The housing may be made of any suitable material(s) such as graphite, carbon fiber, aluminum, etc. Likewise, in some implementations, the location and/or the shape of the payload (e.g., item or container) may be aerodynamically designed. For example, in some implementations, the payload engagement mechanism may be configured such that, when the payload is engaged, it is enclosed within the body and/or housing of the aerial vehicle 100 so that no additional drag is created during transport of the payload by the aerial vehicle 100. In other implementations, the payload may be shaped to reduce drag and provide a more aerodynamic design of the aerial vehicle and the payload. For example, if the payload is a container and a portion of the container extends below the aerial vehicle when engaged, the exposed portion of the container may have a curved shape.

The maneuverability propulsion mechanisms 102 may be positioned at both ends of each rigid member 105. In implementations in which the maneuverability propulsion mechanism includes a motor and one or more propellers, the motor may be any form of motor capable of generating enough speed with the propellers to lift the aerial vehicle 100 and any engaged payload thereby enabling aerial transport of the payload. For example, the maneuverability motor may be a FX-4006-13 740 kv multi rotor motor. Likewise, the propeller may be of any material and size sufficient to provide lift and maneuverability to the aerial vehicle. For example, the propeller may be 10-inch-12-inch diameter carbon fiber propellers. In some implementations, as discussed below, the propeller may be a variable pitched propeller so that the pitch of the propeller blade can be altered during operation of the maneuverability propulsion mechanism. Also, as discussed below, in implementations that include multiple propellers, the distance and/or alignment between the propellers may be adjustable during operation of the maneuverability propulsion mechanism.

The lifting propulsion mechanism 103, as illustrated, may be positioned toward a center of the body 104 of the aerial vehicle. In implementations in which the lifting propulsion mechanism includes a motor and one or more propellers, the motor may be any form of motor capable of generating enough rotational speed with the propeller to create a force that will lift the aerial vehicle 100 and any engaged payload, thereby enabling aerial transport of the payload. For example, the motor may be a RC Tiger U11 124 KV motor. Likewise, the propeller of the lifting propulsion mechanism may be of any material and size sufficient to provide lift to the aerial vehicle. For example, the propeller may be a 29-inch-32-inch diameter carbon fiber propeller. In some implementations, as discussed below, the propeller may be a variable pitched propeller so that the pitch of the propeller blade can be altered during operation of the maneuverability propulsion mechanism. Also, as discussed below, in implementations that include coaxially aligned propellers, the distance between the propellers and/or rotational phase alignment of the propellers may be adjustable during operation of the lifting propulsion mechanism. For example, as the rotational speed of the propellers changes (increases or decreases) the distance between the propellers and/or the rotational phase alignment of the propellers may be adjusted.

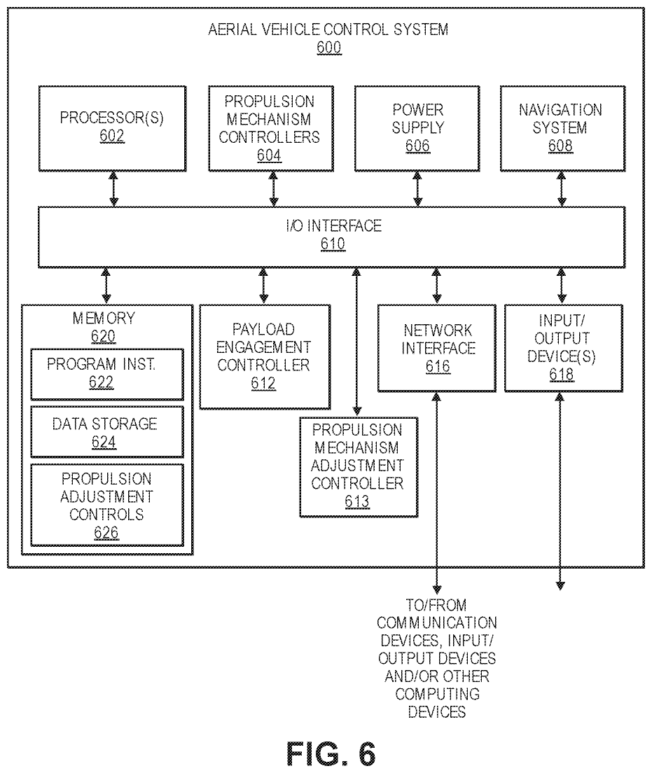

Mounted to the body 104 is the aerial vehicle control system 110. In this example, the aerial vehicle control system 110 is mounted to one side and on top of the body 104. In other implementations, the aerial vehicle control system 110 may be mounted at another location or dispersed about the aerial vehicle 100. The aerial vehicle control system 110, as discussed in further detail below with respect to FIG. 6, controls the operation, routing, navigation, communication, propulsion control, propeller alignment for noise control, and the payload engagement mechanism of the aerial vehicle 100.

Likewise, the aerial vehicle 100 includes one or more power modules 112. In this example, the aerial vehicle 100 includes three power modules 112 that are removably mounted to the body 104. The power module for the aerial vehicle may be in the form of battery power, solar power, gas power, super capacitor, fuel cell, alternative power generation source, or a combination thereof. The power module(s) 112 are coupled to and provide power for the aerial vehicle control system 110, the propulsion mechanisms, and the payload engagement mechanism.

In some implementations, one or more of the power modules may be configured such that it can be autonomously removed and/or replaced with another power module while the aerial vehicle is landed. For example, when the aerial vehicle lands at a delivery location, relay location and/or materials handling facility, the aerial vehicle may engage with a charging member at the location that will recharge the power module.

As mentioned above, the aerial vehicle 100 may also include a payload engagement mechanism. The payload engagement mechanism may be configured to engage and disengage items and/or containers that hold items. In this example, the payload engagement mechanism is positioned beneath the body of the aerial vehicle 100. The payload engagement mechanism may be of any size sufficient to securely engage and disengage containers that contain items. In other implementations, the payload engagement mechanism may operate as the container, containing the item(s). The payload engagement mechanism communicates with (via wired or wireless communication) and is controlled by the aerial vehicle control system 110.

While the implementations of the aerial vehicle 100 discussed herein utilize propulsion mechanisms to achieve and maintain flight, in other implementations, the aerial vehicle may be configured in other manners. For example, the aerial vehicle may include a combination of both propulsion mechanisms and fixed wings. For example, the aerial vehicle may utilize one or more propulsion mechanisms with noise canceling controllers to enable reduced noise VTOL and a fixed wing configuration or a combination wing and propulsion mechanism configuration to sustain flight while the aerial vehicle is airborne.

FIG. 2 depicts a view of another aerial vehicle configuration, according to an implementation. Rather than including rigid members, as discussed above with respect to FIG. 1, the body 204 of the aerial vehicle 200 may be formed of other materials, such as graphite, carbon fiber, aluminum, titanium, etc., or any combination thereof. In this example, the body 204 of the aerial vehicle 100 is a single carbon fiber frame. The body 204 includes a hub 206, propulsion mechanism arms 208, propulsion mechanism mounts 211, and a perimeter protective barrier 214. In this example, there is a single hub 206 and four propulsion mechanism arm sets 108 that extend from the hub 206 to a propulsion mechanism mount 211 and then extend to a perimeter protective barrier 214.

Within each section of the motor arms is a propulsion mechanism 216. In the illustrated aerial vehicle 200 configuration, the aerial vehicle 200 includes four sets of propulsion mechanisms 216-1, 216-2, 216-3, and 216-4. In this configuration, each propulsion mechanism includes two motors and two propellers that are coaxially aligned. For example, as illustrated by the expanded view of propulsion mechanism 216-1, the propulsion mechanisms include an upper motor 216-1A that is coupled to a motor arm on the upper side of the aerial vehicle and a lower motor 216-1D that is coupled to a motor arm on the lower side of the aerial vehicle. The upper motor 216-1A and the lower motor 216-1D are vertically aligned.

The upper motor 216-1A includes a first shaft 216-1E that extends downward toward the lower motor 216-1D, and the lower motor 216-1D includes a second shaft 216-1F that extends upward toward the upper motor 216-1A. Coupled to the first shaft is a first propeller 216-1B that is rotated by the first shaft 216-1E when the first shaft 216-1E is rotated by the upper motor 216-1A. Coupled to the second shaft is a second propeller 216-1C that is rotated by the second shaft 216-1F when the second shaft 216-1F is rotated by the lower motor 216-1D.

The propellers 216-1B, 216-1C, even though coupled to different shafts are coaxially aligned. In addition, the propellers are separated by a distance d₁. Likewise, rather than counter-rotating the propellers 216-1B, 216-1C, during some modes of operation the propellers may be in rotational phase alignment and rotated in the same direction (co-rotated).

Selecting a distance d₁, rotationally phase aligning, and co-rotating the coaxially aligned propellers is done to reduce or otherwise alter noise generated by the high-pressure pulse of the induced flow from the rotation of the propellers. Induced flow is the airflow that is forced through a propeller and moving in the same or similar direction along the axis of the shaft that is rotating the propeller. The induced flow is caused by the deflection of air by the passage of a propeller blade. Induced flow moves downward away from the propeller in a spiral pattern due to the rotation of the propeller blade, creating a sinusoidal waveform at the perimeter of the induced flow. The induced flow includes a high-pressure pulse generated from the tip and other portions of the propeller blade that generates the noise heard from the rotation of the propeller blades. The high-pressure pulse represents a sinusoidal waveform as it spirals down and away from the propeller.

The distance d₁ is selected so that the waveform of the high-pressure pulse induced flow resulting from the rotation of the first propeller 216-1B is substantially out-of-phase (e.g., having polarities that are reversed with respect to polarities of the predicted noises) to the waveform of the high-pressure pulse of the induced flow resulting from the rotation of the second propeller 216-1C, when the first propeller 216-1B is in rotational phase alignment with the second propeller 216-1C. In some implementations, the rotational phase alignment of the two propellers with respect to each other may be adjusted so that the two waveforms to cause destructive interference with one another, thereby reducing the noise from the high-pressure pulses.

By positioning the two coaxially aligned propellers so that the resulting waveforms are out-of-phase, the waveforms cause destructive interference that results in at least a portion of the noise generated by the high-pressure pulses of the induced flows from the two propellers being canceled out or otherwise altered.

The aerial vehicle control system 210 may be mounted to the body of the aerial vehicle and one or more components (e.g., antenna, camera, gimbal, radar, distance-determining elements) may be mounted to body, as discussed above.

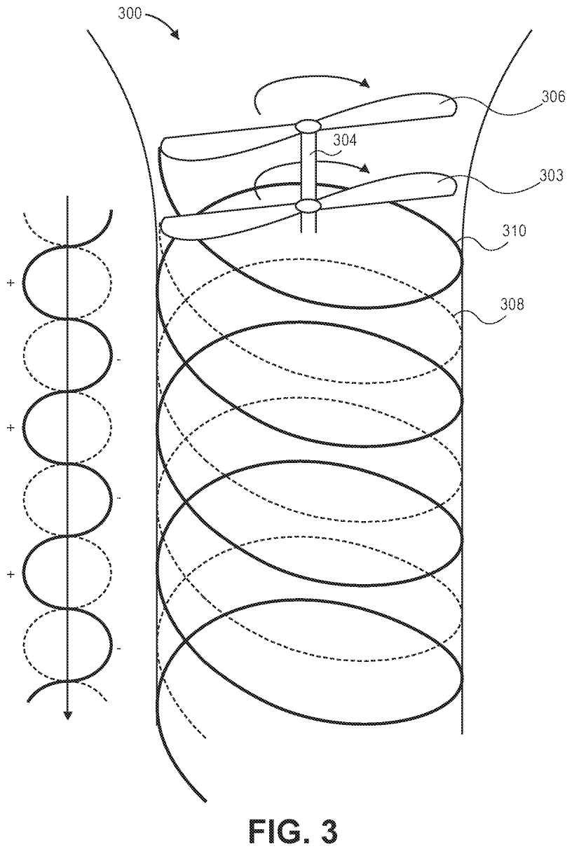

FIG. 3 depicts an illustration of induced flows from a propulsion mechanism that includes two coaxially aligned propellers 303, 306, according to an implementation. For ease of discussion, the motor and other components have been eliminated from the illustration in FIG. 3. As illustrated, the lower propeller 303 and the upper propeller 306 are phase aligned, both rotate in a clockwise direction, and both generate an induced flow that progresses downward away from the propellers.

Coaxially stacked propellers are considered to be phase aligned when there is approximately no offset between the two propellers. For example, the two propellers 303 and 306 are in rotational phase alignment because the propeller blades are aligned so that if viewing the propellers from a top-down perspective you would only be able to see the upper propeller 306. For coaxially stacked propellers having the same design, any arbitrary feature (e.g., leading edges, blade centers, trailing edges, etc.) of the two (or more) propellers may be aligned to achieve phase alignment. However, in circumstances where one or more propellers differ, “phase alignment” may differ depending on which particular feature is being used as a reference point. Thus, for two coaxial but distinct propeller designs, a phase alignment based upon leading edges may differ from phase alignment based upon blade center or trailing edges. Thus, for purposes of specificity, the term “phase alignment” may be modified to be described as “leading edge phase alignment,” “trailing edge phase alignment,” or “blade center phase alignment” when the two propellers have different designs or features. It should be understood by those having ordinary skill that any number of phase alignments may be described and used and that the present disclosure is not limited to alignments based solely upon leading edges, trailing edges, or blade centers.

By phase aligning the coaxially aligned propellers and separating them a defined distance, the waveform generated by the upper propeller 303 will be substantially inverted, or out-of-phase from the waveform generated by the lower propeller 306. The destructive interference of the combined waveforms alters the noise generated by the propulsion mechanism. In selected implementations, the defined distance between propellers 303 and 306 may be calculated based upon the propeller geometry and computational analysis (e.g., computational fluid dynamics or finite element analysis). In other implementations, the distance between propellers may be determined experimentally by adjusting the coaxial spacing of the propellers to alter the noise generated to a more desirable state. In the latter method, audio sensors may be used to provide real-time feedback as the aerial vehicle (e.g., 200 of FIG. 2) is operated.

In this example, the clockwise rotation of the lower propeller 303 generates an induced flow 308 that moves away from the lower propeller 303 in a spiral pattern. Likewise, the clockwise rotation of the upper propeller 306 generates an induced flow 310 that also moves away from the upper propeller 306 in a spiral pattern. Because the lower propeller 303 and the upper propeller 306 are coaxially aligned, rotationally phase aligned, and separated by a defined distance, the waveform or high-pressure pulse of the induced flow 310 from the upper propeller 306 causes destructive interference with the waveform or high-pressure pulse of the induced flow 308 from the lower propeller 303, thereby reducing the noise resulting from the rotation of the propulsion mechanism 300.

While this example illustrates the induced flow waveforms forming off the tips of the propellers 303, 306, it will be appreciated that induced flow waveforms are generated from all segments of the propeller blades at different amplitudes. By offsetting and aligning the propellers in the manner discussed herein, the waveforms generated by each segment of the propellers cause destructive interference and reduce generated noise. Describing the implementations with respect to the induced flow generated from the tips of the propeller blades is for ease of discussion only and it will be appreciated that the implementations are equally applicable to reducing noise generated from waveforms generated along any portion of the propellers as the propellers rotate.

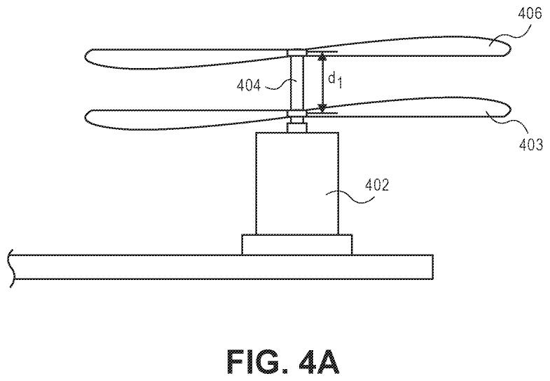

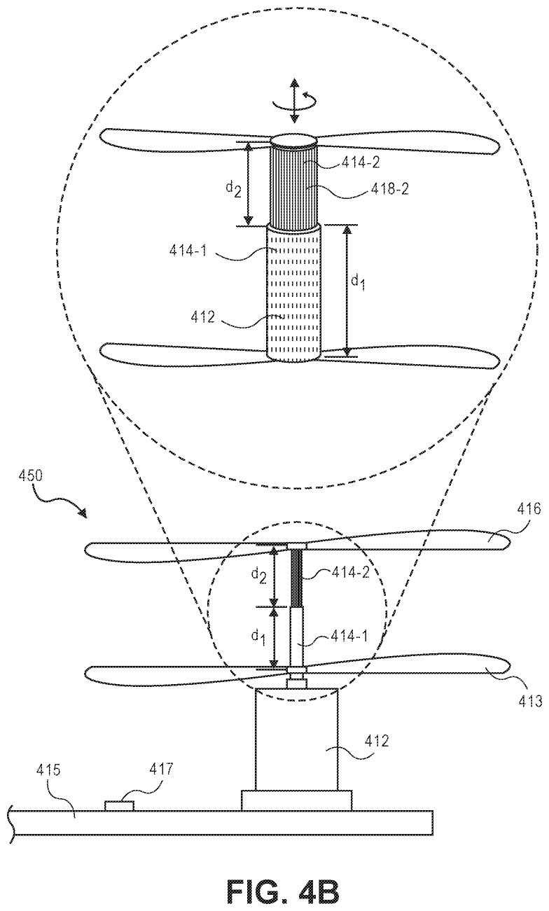

FIGS. 4A-4B depicts the propulsion mechanism 400 with a motor 402, a lower propeller 403, and an upper propeller 406, according to an implementation. In the example illustrated in FIG. 4A, the lower propeller 403 and the upper propeller are coupled to a fixed length shaft 404 and separated a distance d₁. The distance d₁ may be selected based on the operating characteristics of the propulsion mechanism 400. For example, a rotational speed may be determined at which the propulsion mechanism is operating within its most efficient power-to-lift range. Likewise, the pitch of the propeller blades and the resulting waveform generated at that rotational speed may be determined for the lower propeller 403 and the upper propeller 406. Based on the determined waveforms, the distance d₁ may be selected that will cause a waveform from the upper propeller 406 to be substantially out-of-phase of the waveform from the lower propeller 403.

In some implementations, the same propeller size and shape may be used for the upper propeller 406 and the lower propeller 403 so that the generated waveforms and induced flows are symmetrical. However, in other implementations, because of the altered shaped of the airflow passing through the lower propeller 403, due to the induced flow generated by the upper propeller 406, the waveform of the lower propeller 403 may be different. In such an example, the pitch, size, shape and/or other characteristic of either, or both, the upper propeller 406 and the lower propeller 403 may be altered so that the waveforms have approximately the same period and amplitude.

In still other implementations, in addition to separating the upper propeller 406 and the lower propeller 403, the rotational phase alignment of the propeller blades may be offset a defined amount so that the combination of the distance d₁ and the alignment offset of the propeller blades results in the waveform of the induced flow from the upper propeller 406 to be substantially out-of-phase from the induced flow from the lower propeller 403.

In the example illustrated in FIG. 4B, the lower propeller 413 and the upper propeller 416 are coupled to an adjustable length shaft 404. As illustrated in the expanded view, the adjustable shaft may be adjusted radially (extended or retracted) or rotationally (clockwise or counter-clockwise). In some implementations, a sensor 417, such as a microphone, may be affixed to the motor arm 415 to which the propulsion mechanism 450 is attached. The sensor 417 may measure sound generated by the propulsion mechanism and the shaft may be adjusted so that the waveforms of the high-pressure pulses from the induced flow generated by each of the propellers 413, 416 are out-of-phase and cause destructive interference, thereby reducing the generated sound. For example, the shaft may be radially extended a distance d₂ to increase the separation of the lower propeller 413 and the upper propeller 416. As the shaft is extended, the sensor may continue to measure the generated sound and provide feedback to the aerial vehicle control system indicating whether the sound is increasing or decreasing. The shaft may continue to be extended until the sound stops decreasing. Alternatively, the shaft may be contracted and the sound measured by the sensor 417 to determine when to stop contracting the shaft 414.

In addition to extending or contracting the shaft 414, the alignment of the propellers 413, 416 may be adjusted by rotating the upper portion of the shaft 414-2 with respect to the lower portion of the shaft 414-1. Adjusting the rotational phase alignment of the propellers 413, 416 may be done in addition to or as an alternative to adjusting the distance between the propellers 413, 416. For example, once a distance between the propellers is determined at which the generated noise is at a minimum for that rotational speed of the propulsion mechanism, the rotational phase alignment of the propellers 413, 416 may be adjusted. During adjustment of the rotational phase alignment of the propellers, the sensor 417 may continue to measure the generated sound to determine an alignment in which the generated sound is at its lowest.

In still another example, the pitch of one or more propeller blades of the lower propeller 413 and/or the upper propeller 416 may be adjustable to alter the waveform of the induced flow from the propeller. As the pitch of the propeller increases, the lift generated by the propeller also increases for the same rotational speed. Likewise, the waveform of the induced flow is altered. In some implementations, the sensor 417 may measure the sound generated by the propulsion mechanism as the pitch of one or more propeller blades is altered to determine when a minimum noise level is reached.

The adjustment of the shaft (radially and/or rotationally), and/or the pitch of the propeller blades may be continuously or periodically performed during operation of the aerial vehicle. Alternatively, certain areas or altitudes may be designated as reduced noise areas and the adjustment of the propulsion mechanism may only be made when the aerial vehicle is operating on those areas.

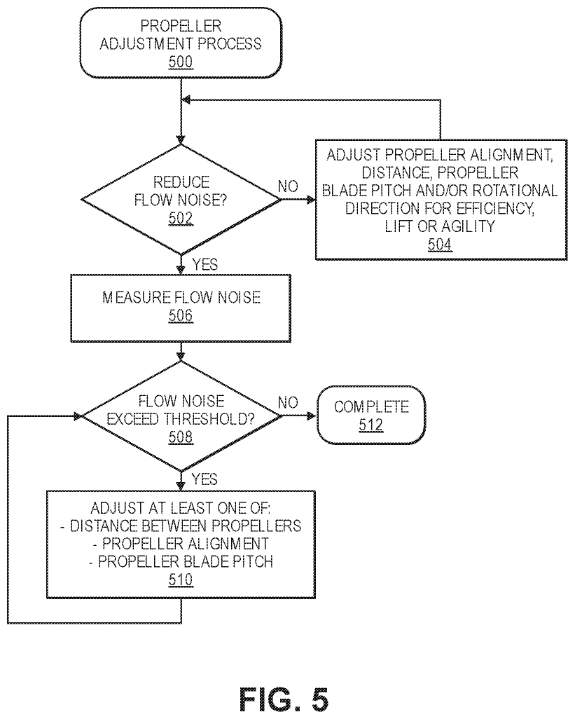

FIG. 5 is a flow diagram illustrating an example propeller noise adjustment process 500, according to an implementation. The example process 500 of FIG. 5 and each of the other processes discussed herein may be implemented in hardware, software, or a combination thereof. In the context of software, the described operations represent computer-executable instructions stored on one or more computer-readable media that, when executed by one or more processors, perform the recited operations. Generally, computer-executable instructions include routines, programs, objects, components, data structures, and the like that perform particular functions or implement particular abstract data types.

The computer-readable media may include non-transitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some implementations the computer-readable media may include a transitory computer-readable signal (in compressed or uncompressed form). Examples of computer-readable signals, whether modulated using a carrier or not, include, but are not limited to, signals that a computer system hosting or running a computer program can be configured to access, including signals downloaded through the Internet or other networks. Finally, the order in which the operations are described is not intended to be construed as a limitation, and any number of the described operations can be combined in any order and/or in parallel to implement the routine.

The example process 500 begins by determining if the noise from the induced flow of a propulsion mechanism is to be reduced, as in 502. In some implementations, it may be determined that noise from induced flow is to be reduced during any operation of the aerial vehicle. In other implementations, it may be determined that noise from the induced flow of a propulsion mechanism is only to be performed when the aerial vehicle is in designated areas or below designated altitudes.

If it is determined that the noise from the induced flow is not be reduced, the distance between the propellers of the propulsion mechanism, the rotational phase alignment of the propellers, the pitch of one or more of the propeller blades, and/or the rotational direction of the propellers may be adjusted so that the propulsion mechanism is optimized for efficiency, lift, or agility, as in 504. For example, reducing noise using the techniques discussed herein may reduce the lift, and thus efficiency, of the propulsion mechanism. If reduced noise is not needed, such as when the aerial vehicle is flying at a high altitude, the propulsion mechanism may be adjusted to optimize for efficiency.

However, if it is determined that the noise resulting from the induced flow of the propulsion mechanism is to be reduced, the flow noise is measured by one or more sensors positioned on the aerial vehicle, as in 506. As discussed above, the sensor may be positioned on a motor arm beneath the propeller of the propulsion mechanism, or at another location.

Based on the measured noise, a determination is made as to whether the noise exceeds a threshold, as in 508. If it is determined that the measured noise exceeds a threshold, at least one of the distance between the propellers of the propulsion mechanism, the rotational phase alignment of the propellers of the propulsion mechanism, or the pitch of one or more of the blades of the propellers of the propulsion mechanism are adjusted to decrease the noise generated by the propulsion mechanism, as in 510. The process of making one or more the adjustments discussed with respect to block 510 may be continually performed until the measured noise is below the threshold. Alternatively, adjustments may be periodically made and the measured noise compared to a measured noise prior to the adjustment. If the current measured noise is less than the prior measured noise, additional adjustments are made. If the measured noise is greater than the prior measured noise, the adjustment is removed. This process of adjusting one or more components of the propulsion mechanism may continue until it is determined that the noise from the propulsion mechanism is not longer to be reduced (e.g., the aerial vehicle as ceased operation, or the aerial vehicle has navigated out of a designated area). If it is determined that the threshold is not exceeded, the example process completes, as in 512.

While the implementations discussed herein are described with respect to lifting propulsion mechanisms and maneuverability propulsion mechanisms, it will be appreciated that the implementations are equally applicable to other propulsion mechanisms that may be utilized on an aerial vehicle. For example, the aerial vehicle may include one or more thrusting propulsion mechanisms that provide horizontal thrust to propel the aerial vehicle horizontally. In such an implementation, the thrusting propulsion mechanism(s) may be configured with the implementations discussed herein to reduce noise generated by rotation of the propeller blades of the thrusting propulsion mechanism(s).

FIG. 6 is a block diagram illustrating an example aerial vehicle control system 600 of an aerial vehicle. In various examples, the block diagram may be illustrative of one or more aspects of the aerial vehicle control system 600 that may be used to implement the various systems and methods discussed herein and/or to control operation of the aerial vehicle. In the illustrated implementation, the aerial vehicle control system 600 includes one or more processors 602, coupled to a memory, e.g., a non-transitory computer readable storage medium 620, via an input/output (I/O) interface 610. The aerial vehicle control system 600 also includes propulsion mechanism controllers 604, such as electronic speed controls (ESCs), one or more power supply modules 606, and/or a navigation system 608. The aerial vehicle control system 600 may also include a payload engagement controller 612, a network interface 616, one or more input/output devices 618, and an induced flow noise controller 613. The induced flow noise controller may receive information from a sensor and determine adjustments to be made to each of the propulsion mechanisms to decrease the noise generated from the induced flow of the propulsion mechanism, using any one or more of the implementations discussed above.

In various implementations, the aerial vehicle control system 600 may be a uniprocessor system including one processor 602, or a multiprocessor system including several processors 602 (e.g., two, four, eight, or another suitable number). The processor(s) 602 may be any suitable processor capable of executing instructions. For example, in various implementations, the processor(s) 602 may be general-purpose or embedded processors implementing any of a variety of instruction set architectures (ISAs), such as the x86, PowerPC, SPARC, or MIPS ISAs, or any other suitable ISA. In multiprocessor systems, each processor(s) 602 may commonly, but not necessarily, implement the same ISA.

The non-transitory computer readable storage medium 620 may be configured to store executable instructions, data, flight paths, profiles, flight control parameters, and/or data items accessible by the processor(s) 602. In various implementations, the non-transitory computer readable storage medium 620 may be implemented using any suitable memory technology, such as static random access memory (SRAM), synchronous dynamic RAM (SDRAM), nonvolatile/Flash-type memory, or any other type of memory. In the illustrated implementation, program instructions and data implementing desired functions, such as those described herein, are shown stored within the non-transitory computer readable storage medium 620 as program instructions 622, data storage 624 and propulsion adjustment controls 626, respectively. In other implementations, program instructions, data, and/or propulsion adjustment controls may be received, sent, or stored upon different types of computer-accessible media, such as non-transitory media, or on similar media separate from the non-transitory computer readable storage medium 620 or the aerial vehicle control system 600. Generally speaking, a non-transitory, computer readable storage medium may include storage media or memory media such as magnetic or optical media, e.g., disk or CD/DVD-ROM, coupled to the aerial vehicle control system 600 via the I/O interface 610. Program instructions and data stored via a non-transitory computer readable medium may be transmitted by transmission media or signals such as electrical, electromagnetic, or digital signals, which may be conveyed via a communication medium such as a network and/or a wireless link, such as may be implemented via the network interface 616.

In one implementation, the I/O interface 610 may be configured to coordinate I/O traffic between the processor(s) 602, the non-transitory computer readable storage medium 620, and any peripheral devices, the network interface or other peripheral interfaces, such as input/output devices 618. In some implementations, the I/O interface 610 may perform any necessary protocol, timing or other data transformations to convert data signals from one component (e.g., non-transitory computer readable storage medium 620) into a format suitable for use by another component (e.g., processor(s) 602). In some implementations, the I/O interface 610 may include support for devices attached through various types of peripheral buses, such as a variant of the Peripheral Component Interconnect (PCI) bus standard or the Universal Serial Bus (USB) standard, for example. In some implementations, the function of the I/O interface 610 may be split into two or more separate components, such as a north bridge and a south bridge, for example. Also, in some implementations, some or all of the functionality of the I/O interface 610, such as an interface to the non-transitory computer readable storage medium 620, may be incorporated directly into the processor(s) 602.

The propulsion mechanism controllers 604 communicate with the navigation system 608 and adjust the rotational speed of each lifting motor and/or the pushing motor to stabilize the aerial vehicle and guide the aerial vehicle along a determined flight path.

The navigation system 608 may include a global positioning system (GPS), indoor positioning system (IPS), or other similar system and/or sensors that can be used to navigate the aerial vehicle 100 to and/or from a location. The payload engagement controller 612 communicates with the actuator(s) or motor(s) (e.g., a servo motor) used to engage and/or disengage items.

The network interface 616 may be configured to allow data to be exchanged between the aerial vehicle control system 600, other devices attached to a network, such as other computer systems (e.g., remote computing resources), and/or with aerial vehicle control systems of other aerial vehicles. For example, the network interface 616 may enable wireless communication between the aerial vehicle 100 and an aerial vehicle control system that is implemented on one or more remote computing resources. For wireless communication, an antenna of the aerial vehicle or other communication components may be utilized. As another example, the network interface 616 may enable wireless communication between numerous aerial vehicles. In various implementations, the network interface 616 may support communication via wireless general data networks, such as a Wi-Fi network. For example, the network interface 616 may support communication via telecommunications networks, such as cellular communication networks, satellite networks, and the like.

Input/output devices 618 may, in some implementations, include one or more displays, imaging devices, thermal sensors, infrared sensors, time of flight sensors, accelerometers, pressure sensors, weather sensors, microphones, speakers, etc. Multiple input/output devices 618 may be present and controlled by the aerial vehicle control system 600.

As shown in FIG. 6, the memory may include program instructions 622, which may be configured to implement the example routines and/or sub-routines described herein. The data storage 624 may include various data stores for maintaining data items that may be provided for determining flight paths, landing, identifying locations for disengaging items, etc. The propulsion adjustment controls may include, for example, predetermined configurations of propulsion mechanisms that will result in reduced noise at different rotational speeds. Such information may be provided to the propulsion mechanism noise controller 613 as adjustments are made to the propulsion mechanisms.

In various implementations, the parameter values and other data illustrated herein as being included in one or more data stores may be combined with other information not described or may be partitioned differently into more, fewer, or different data structures. In some implementations, data stores may be physically located in one memory or may be distributed among two or more memories.

Those skilled in the art will appreciate that the aerial vehicle control system 600 is merely illustrative and is not intended to limit the scope of the present disclosure. In particular, the computing system and devices may include any combination of hardware or software that can perform the indicated functions. The aerial vehicle control system 600 may also be connected to other devices that are not illustrated, or instead may operate as a stand-alone system. In addition, the functionality provided by the illustrated components may, in some implementations, be combined in fewer components or distributed in additional components. Similarly, in some implementations, the functionality of some of the illustrated components may not be provided and/or other additional functionality may be available.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated aerial vehicle control system 600. Some or all of the system components or data structures may also be stored (e.g., as instructions or structured data) on a non-transitory, computer-accessible medium or a portable article to be read by an appropriate drive. In some implementations, instructions stored on a computer-accessible medium separate from the aerial vehicle control system 600 may be transmitted to the aerial vehicle control system 600 via transmission media or signals such as electrical, electromagnetic, or digital signals, conveyed via a communication medium such as a wireless link. Various implementations may further include receiving, sending, or storing instructions and/or data implemented in accordance with the foregoing description upon a computer-accessible medium. Accordingly, the techniques described herein may be practiced with other aerial vehicle control system configurations.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. An aerial vehicle apparatus, comprising:
a body;
a lifting propulsion mechanism, the lifting propulsion mechanism including:
a first motor coupled to the body;
a first shaft coupled to and rotatable by the first motor that extends from the first motor;
a first propeller coupled to and rotatable by the first shaft;
a second motor coupled to the body;
a second shaft coupled to and rotatable by the second motor, wherein the second shaft is coaxially aligned with the first shaft and extends from the second motor toward the first motor; and
a second propeller coupled to the second shaft at a distance from the first propeller coupled to the first shaft; and
a control system configured to at least:
during operation of the aerial vehicle apparatus, send an instruction that causes adjustment of at least one of an alignment, a direction of rotation, or a pitch of at least one of the first propeller or the second propeller.

2. The aerial vehicle apparatus of claim 1, further comprising:
a plurality of maneuverability propulsion mechanisms, each of the plurality of maneuverability propulsion mechanisms configured to maneuver the aerial vehicle apparatus during flight.

3. The aerial vehicle apparatus of claim 2, wherein at least one of the maneuverability propulsion mechanisms includes:
a third motor coupled to the body;
a third shaft coupled to and rotatable by the third motor that extends from the third motor;
a third propeller coupled to and rotatable by the third shaft;
a fourth motor coupled to the body;
a fourth shaft coupled to and rotatable by the fourth motor, wherein the fourth shaft is coaxially aligned with the third shaft and extends from the fourth motor toward the third motor; and
a fourth propeller coupled to the fourth shaft at a second distance from the third propeller coupled to the third shaft.

4. The aerial vehicle apparatus of claim 1, wherein the first propeller and the second propeller are in a phase alignment.

5. The aerial vehicle apparatus of claim 1, wherein the control system is further configured to at least:
send a second instruction to adjust a pitch of the second propeller based at least in part on a measured sound generated by the lifting propulsion mechanism.

6. The aerial vehicle apparatus of claim 1, wherein the control system is further configured to at least:
send a second instruction to adjust a phase alignment of the first propeller and the second propeller based at least in part on a measured sound generated by the lifting propulsion mechanism.

7. The aerial vehicle apparatus of claim 1, wherein the control system is further configured to at least:
during operation of the aerial vehicle apparatus, measure a noise generated by the aerial vehicle apparatus;
determine that the noise exceeds a threshold; and
wherein the instruction is sent in response to a determination that the noise exceeds the threshold.

8. A method to reduce a noise generated by an aerial vehicle during a flight, the method comprising:
flying the aerial vehicle using a propulsion mechanism of the aerial vehicle, the propulsion mechanism comprising a first propeller rotated by a first shaft and a second propeller rotated by a second shaft, the first propeller and the second propeller being coaxially aligned and separated from each other by a distance; and
during the flight of the aerial vehicle, adjusting at least one of an alignment, a direction of rotation, or a pitch of at least one of the first propeller or the second propeller of the propulsion mechanism such that a first noise generated by a first induced flow of the first propeller cancels out at least a portion of a second noise generated by a second induced flow of the second propeller.

9. The method of claim 8, further comprising:
determining that a noise generated by the propulsion mechanism exceeds a threshold; and
wherein adjusting at least one of the alignment, the direction of rotation, or the pitch of at least one of the first propeller or the second propeller is in response to determining that the noise exceeds the threshold.

10. The method of claim 8, wherein adjusting at least one of the alignment, the direction of rotation, or the pitch of at least one of the first propeller or the second propeller is determined based at least in part on a rotational speed of the first propeller or the second propeller, a size of the first propeller or the second propeller, a measured first noise, a measured second noise, an alignment of the first propeller and the second propeller, or a pitch of at least one propeller blade of the first propeller or the second propeller.

11. The method of claim 8, wherein the pitch of at least one propeller blade of the first propeller is adjusted to alter a pattern of the first induced flow.

12. The method of claim 8, wherein the alignment of at least one of the first propeller or the second propeller is adjusted such that a waveform pattern of the first induced flow is approximately out-of-phase from a waveform pattern of the second induced flow.

13. The method of claim 8, further comprising:
measuring, with a sensor positioned on the aerial vehicle, the first noise; and
adjusting at least one of the alignment, the direction of rotation, or the pitch of at least one of the first propeller or the second propeller until the measured first noise is less than a threshold.

14. The method of claim 8, further comprising:
determining that the aerial vehicle is within a noise reduction area; and
wherein adjusting at least one of the alignment, the direction of rotation, or the pitch of at least one of the first propeller or the second propeller is in response to determining that the aerial vehicle is within the noise reduction area.

15. The method of claim 14, further comprising:
determining that the aerial vehicle has exited the noise reduction area; and
adjusting at least one of the alignment, the direction of rotation, or the pitch of at least one of the first propeller or the second propeller to increase at least one of a force generated by the propulsion mechanism or an efficiency of the propulsion mechanism.

16. An unmanned aerial vehicle (“UAV”), comprising:
a body;
a propulsion mechanism coupled to the body, including:
a first motor;
a first shaft coupled to and extending from the first motor;
a first propeller coupled to the first shaft and rotatable by the first shaft in a first direction;
a second motor;
a second shaft coupled to and extending from the second motor, the second shaft being coaxially aligned with the first shaft; and
a second propeller coupled to the second shaft, coaxially aligned with and at a distance from the first propeller, and rotatable by the second shaft in the first direction; and
a control system configured to at least:
during operation of the UAV, send an instruction that causes adjustment of at least one of an alignment, a direction of rotation, or a pitch of at least one of the first propeller or the second propeller.

17. The UAV of claim 16, wherein the at least one of the alignment, the direction of rotation, or the pitch of at least one of the first propeller or the second propeller is determined based at least in part on a rotational speed of at least one of the first shaft or the second shaft.

18. The UAV of claim 16, wherein the at least one of the alignment, the direction of rotation, or the pitch of at least one of the first propeller or the second propeller is determined based at least in part on a measured noise generated by the UAV.

19. The UAV of claim 16, further comprising:
a sensor configured to measure a noise generated by the UAV; and
wherein the instruction is sent based at least in part on the measured noise.

20. The UAV of claim 16, wherein the control system is further configured to at least:
monitor, as at least one of the alignment, the direction of rotation, or the pitch of at least one of the first propeller or the second propeller is adjusted, a noise generated by the UAV; and
continue to instruct adjustment until the measured noise is below a threshold.
